(19) United States
(12) Patent Application Publication
(10) Pub. No.: US 2025/0227359 A1
(43) Pub. Date: Jul. 10, 2025

(54) IMAGING SYSTEM

(71) Applicant: CANON KABUSHIKI KAISHA, Tokyo (JP)

(72) Inventors: TAKUMA JIKO, Kanagawa (JP); MASAHIRO FUNADA, Tochigi (JP)

(21) Appl. No.: 18/980,383

(22) Filed: Dec. 13, 2024

(30) Foreign Application Priority Data
Jan. 10, 2024 (JP) 2024-001978

(51) Int. Cl. H04N 23/63; H04N 23/62; H04N 23/67; H04N 23/73

(52) U.S. Cl. CPC H04N 23/632; H04N 23/62; H04N 23/67; H04N 23/73

(57) ABSTRACT

An imaging system includes an image sensor, and a plurality of output interfaces capable of outputting an output image to an outside on a basis of an original image captured by the image sensor. The imaging system executes first setting processing of setting areas of a plurality of output images respectively output from the plurality of output interfaces from the original image, the first setting processing being capable of setting mutually different areas as the areas of the plurality of output images, executes second setting processing of individually setting a setting value for each of the areas of the plurality of output images, and executes adjustment processing of performing adjustment of entire of the original image using the setting value set for a first area among the areas of the plurality of output images.

### BACKGROUND OF THE INVENTION

### Field of the Invention

The present invention relates to an imaging system capable of performing crop processing.

### Description of the Related Art

There is an imaging system having a crop function that cuts out and uses a part of a captured image. In this imaging system, normally, adjustment of a focal point, exposure, color balance, and the like that affect the entire captured image is performed such that a cut-out image is preferable. At this time, it can be said that a sensing area in a case where the adjustment of these is automatically performed is preferably accommodated in a crop area. JP 2006-222816 A discloses a technique of creating and correcting a temporary correction value of a switching destination using information of a wide-angle image (entire area) in order to quickly apply an adjustment value at the time of switching a target image (crop area) in a system that cuts out and uses the target image from the wide-angle image.

The present inventors have developed an imaging system having a function capable of generating output images of different crop areas from one image source (original image) and simultaneously outputting the output images to the outside via a plurality of output terminals. In a case where a plurality of output images is simultaneously output as described above, it is difficult to automatically determine how to set adjustment of a focal point, exposure, color balance, and the like. This is because brightness and an object of an image varies depending on a crop area, and therefore when adjustment is performed according to a certain crop area, image quality of another crop area may be deteriorated. In addition, a device cannot automatically determine which image of a plurality of output images is most emphasized in terms of quality by a user.

### SUMMARY OF THE INVENTION

The present invention provides an imaging system with excellent usability, the imaging system enabling a user to easily set desired adjustment.

The present disclosure includes an imaging system including an image sensor, a plurality of output interfaces capable of outputting an output image to an outside on a basis of an original image captured by the image sensor, one or more processors, and one or more memories storing one or more programs which, when executed by the one or more processors, cause the imaging system to execute first setting processing of setting areas of a plurality of output images respectively output from the plurality of output interfaces from the original image, the first setting processing being capable of setting mutually different areas as the areas of the plurality of output images, execute second setting processing of individually setting a setting value for each of the areas of the plurality of output images, and execute adjustment processing of performing adjustment of entire of the original image using the setting value set for a first area among the areas of the plurality of output images.

Further features of the present invention will become apparent from the following description of exemplary embodiments with reference to the attached drawings.

### BRIEF DESCRIPTION OF THE DRAWINGS

FIG. 1 is a diagram illustrating a configuration of an imaging system in a first embodiment;

FIG. 2 is a diagram illustrating an example of an original image captured by an imaging device in the first embodiment;

FIG. 3 is a diagram illustrating an example of a crop setting screen in the first embodiment;

FIG. 4 is a diagram illustrating an image of a crop 1 area cut out from the original image of FIG. 2;

FIG. 5 is a diagram illustrating an image of a crop 2 area cut out from the original image of FIG. 2;

FIG. 6 is a diagram illustrating an original image captured by performing adjustment such that exposure of a crop 2 is appropriate;

FIG. 7 is a diagram illustrating an image of the crop 1 area cut out from the original image of FIG. 6;

FIG. 8 is a diagram illustrating an image of the crop 2 area cut out from the original image of FIG. 6;

FIG. 9 is a flowchart of user setting application processing in the first embodiment;

FIG. 10 is a diagram illustrating a configuration of an imaging system in a second embodiment;

FIG. 11 is a diagram illustrating an example of a crop setting screen in the second embodiment;

FIG. 12 is a flowchart of exposure correction processing;

FIG. 13 is a diagram illustrating an exposure correction processing result in each block in the second embodiment;

FIG. 14 is a diagram illustrating a configuration of an imaging system in a third embodiment;

FIG. 15 is a diagram illustrating an example of an original image captured by an imaging device in the third embodiment;

FIG. 16 is a diagram illustrating an example of a crop setting screen in the third embodiment;

FIG. 17 is a diagram illustrating an image of a crop 1 area cut out from the original image of FIG. 15;

FIG. 18 is a diagram illustrating an image of a crop 2 area cut out from the original image of FIG. 15;

FIG. 19 is a diagram illustrating an original image captured by performing autofocus adjustment with setting of a crop 2;

FIG. 20 is a diagram illustrating an image of the crop 1 area cut out from the original image of FIG. 19;

FIG. 21 is a diagram illustrating an image of the crop 2 area cut out from the original image of FIG. 19;

FIG. 22 is a flowchart of user setting application processing in the third embodiment;

FIG. 23 is a diagram illustrating a configuration of an imaging system in a fourth embodiment;

FIG. 24 is a flowchart of processing of an adjustment unit when an adjustment reference area is changed;

FIG. 25 is a diagram illustrating a configuration of an imaging system in a fifth embodiment;

FIG. 26 is a diagram illustrating an example of an original image captured by an imaging device in the fifth embodiment;

FIG. 27 is a diagram illustrating an example of a crop 1-selected AF setting screen in the fifth embodiment;

FIG. 28 is a diagram illustrating an example of a crop 1-selected AF position setting screen in the fifth embodiment; and

FIG. 29 is a diagram illustrating an example of a crop 2-selected AF position setting screen in the fifth embodiment.

### DESCRIPTION OF THE EMBODIMENTS

### First Embodiment

Hereinafter, a first embodiment of the present invention will be described. In the first embodiment, an exposure adjustment method in an imaging system, capable of outputting images selected as different crop areas to a plurality of output units will be described.

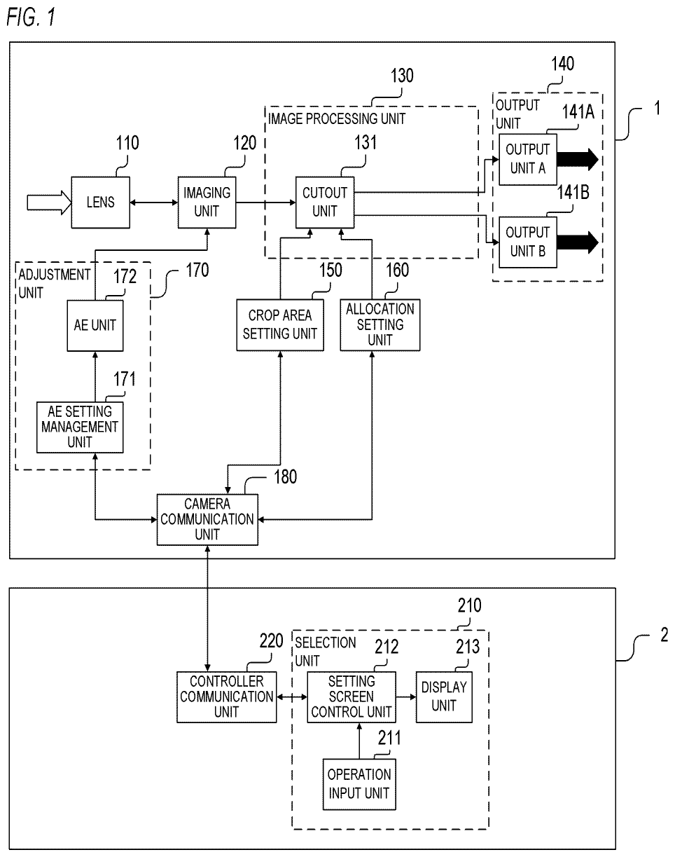

FIG. 1 is a diagram illustrating a configuration of an imaging system in the first embodiment. The imaging system includes an imaging device 1 and a controller device 2. The imaging device 1 includes a lens 110, an imaging unit 120, an image processing unit 130, an output unit 140, a crop area setting unit 150, an allocation setting unit 160, an adjustment unit 170, and a camera communication unit 180.

The lens 110 is a mechanism including an optical component that takes in light and forms an image on the imaging unit 120, and the lens can be moved for zooming or focus adjustment. The imaging unit 120 is an imaging sensor that converts light that has been taken in into an electrical signal. The image processing unit 130 is an image processing circuit that performs various types of image processing on the electrical signal converted by the imaging unit 120 and converts the electrical signal into an image signal, and includes a cutout unit 131 and a plurality of image processing blocks (not illustrated). Hereinafter, a raw image captured by the imaging unit 120 and taken by the image processing unit 130 is referred to as “original image”.

The output unit 140 is an image output interface that outputs an image signal such as HDMI (registered trademark) or serial digital interface (SDI) to the outside, and includes a plurality of output units such as an output unit A141A and an output unit B141B. The crop area setting unit 150 (area setting unit) performs control to perform area setting of crop processing of cutting out a part of an image signal. The allocation setting unit 160 (allocation unit) performs allocation control of the plurality of output units included in the output unit 140 and the crop areas. The adjustment unit 170 includes an AE setting management unit 171, an AE unit 172, and a storage area (not illustrated), and performs control such as management and adjustment of various parameter settings related to exposure in the imaging unit 120. The camera communication unit 180 is a communication interface that communicates with the controller device 2 and other devices.

The controller device 2 includes a selection unit 210 and a controller communication unit 220. The selection unit 210 includes an operation input unit 211 that receives an input from a user, a setting screen control unit 212 that creates a screen to be presented to the user, and a display unit 213 that displays the created setting screen. The selection unit 210 provides a user interface (UI) (first setting unit) for setting areas of a plurality of output images to be output from the plurality of output units, respectively, a UI (second setting unit) for setting individual setting values for the areas of the plurality of output images, respectively, and the like. The controller communication unit 220 is a communication interface that communicates with the imaging device 1 and other devices.

Note that, although not illustrated in the present embodiment for simplification of description, the imaging device 1 may include a recording unit (not illustrated) that records image data on a recording medium such as a built-in memory or an SD card. In addition, a live view image may be transmitted from the imaging device 1 to the controller device 2 such that a live view image can be viewed with the controller device 2.

First, processing of converting light taken in from the lens into an image signal output by the imaging device 1 and outputting an image to the outside will be described. Light collected by the lens 110 is photoelectrically converted in the imaging unit 120. The image processing unit 130 performs various types of image processing on the photoelectrically converted imaging signal to generate an image signal. The output unit 140 is an external output such as HDMI or SDI. The image signal generated by the image processing unit 130 is output from the output unit 140 to the outside, and the image signal is transmitted to a connected monitor, switcher, or the like.

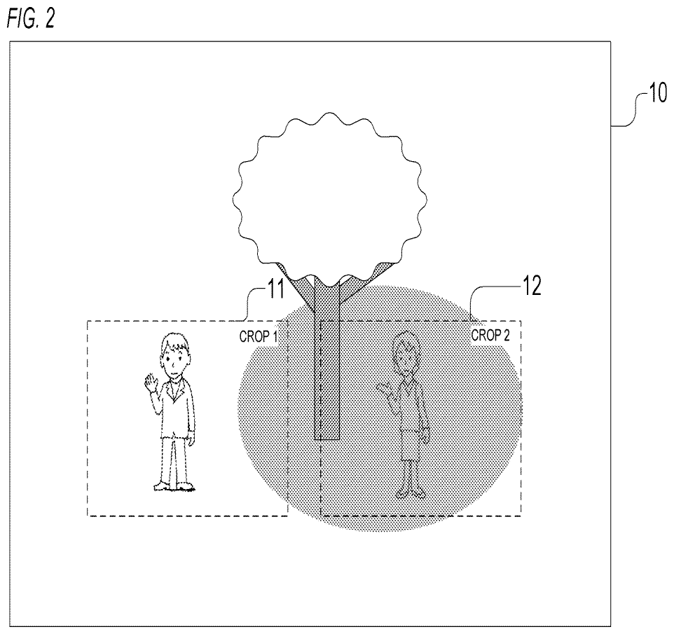

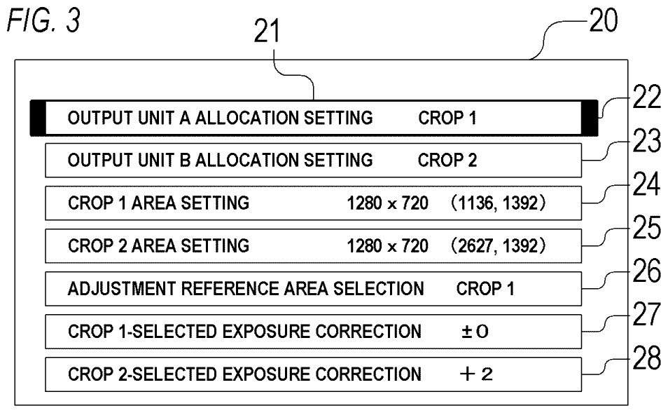

Next, crop processing of cutting out a part of the image signal will be described. FIG. 2 illustrates an example of an image captured by the imaging device 1, and FIG. 3 is a diagram illustrating an example of an operation screen displayed on the selection unit 210 of the controller device 2.

A crop setting screen 20 illustrated in FIG. 3 includes a menu cursor 21 indicating a currently selected item and the following seven items (22 to 28). An output unit A allocation setting item 22 is an item for performing setting of a crop area to be allocated to the output unit A141A (that is, an area of an image output from an output terminal of an output unit A). An output unit B allocation setting item 23 is an item for performing setting of a crop area to be allocated to the output unit B141B (that is, an area of an image output from an output terminal of an output unit B). A crop 1 area setting item 24 is an item for performing setting of the size and position of a crop 1. A crop 2 area setting item 25 is an item for performing setting of the size and position of a crop 2. An adjustment reference area selection item 26 is an item for selecting an area to be a reference of correction of various adjustment values, and a full screen, the crop 1, and the crop 2 can be selected. Items 27 and 28 are items for setting an individual setting value for each area. The crop 1-selected exposure correction item 27 is an item for performing setting of an exposure correction value to be applied when the crop 1 is selected in the adjustment reference area selection item 26. The crop 2-selected exposure correction item 28 is an item for performing setting of an exposure correction value to be applied when the crop 2 is selected in the adjustment reference area selection item 26.

In FIG. 2, an area surrounded by a solid line 10 indicates a full-screen area imaged by the imaging unit 120, and an area surrounded by each of broken lines 11 and 12 indicates a crop area, and any cutout size and position can be designated by the selection unit 210 of the controller device 2. In a case where a live view can be confirmed with the controller device 2 as the imaging system, an image in which each crop frame can be visually recognized as in the image of FIG. 2 can also be preferably displayed. In addition, the number of each crop area (such as “crop 1” or “crop 2”) is preferably displayed together with the crop frame. Information regarding the size and position of each crop area is displayed in the crop 1 area setting item 24 and the crop 2 area setting item 25. In a case of the contents illustrated in FIG. 3, the size of the crop area of the crop 1 is 1280×720 and the position of center coordinates thereof is (1136, 1392), and the size of the crop area of the crop 2 is 1280×720 and the position of center coordinates thereof is (2627, 1392). As a method for designating the position and size of the crop area, an enlargement/reduction operation or a movement operation may be performed by selecting the broken line 11 or 12, or setting may be performed by inputting a value in the crop 1 area setting item 24 or the crop 2 area setting item 25 of the crop setting screen 20 illustrated in FIG. 3.

The information regarding the size and position of the crop area designated by the selection unit 210 is transmitted from the controller communication unit 220 to the camera communication unit 180. The camera communication unit 180 determines the received information, and transmits the information to the crop area setting unit 150 in a case where the information is information regarding the cutout size and position of the crop area.

The crop area setting unit 150 performs setting of the cutout unit 131 on the basis of the transmitted information regarding the cutout size and position of the crop area. The cutout unit 131 is a part of a circuit included in the image processing unit 130, and can generate an image signal obtained by cutting out any area from a captured image. The image signal generated by the cutout unit 131 is subjected to various types of image processing by the image processing unit 130, then transmitted to the output unit 140, and output to the outside as an image signal cut out in the designated crop area.

Next, a method for allocating the image cut out in the crop area and the output unit will be described. As illustrated in FIG. 2, a plurality of crop areas can be set, and as illustrated in FIG. 1, the output unit 140 includes a plurality of output units. Therefore, it is necessary to designate an output unit to which an image is output and a crop area in which the image is included. Hereinafter, an example of a designation method thereof and processing to be executed will be described.

Selection items of the output unit A allocation setting item 22 and the output unit B allocation setting item 23 in FIG. 3 include a full screen, the crop 1, and the crop 2, and it is possible to set an area to be allocated to a corresponding output unit. When setting is performed by the output unit A allocation setting item 22 and the output unit B allocation setting item 23, the set allocation information is transmitted from the controller communication unit 220 to the camera communication unit 180. The camera communication unit 180 determines whether or not the received information is allocation information, and transmits the allocation information to the allocation setting unit 160. The allocation setting unit 160 controls an output destination of the image signal cut out by the cutout unit 131 or the full-screen image signal on the basis of the transmitted allocation information.

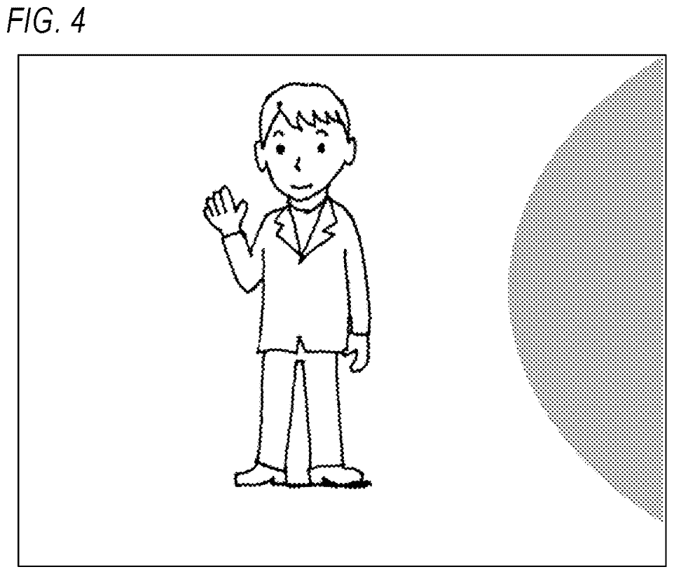

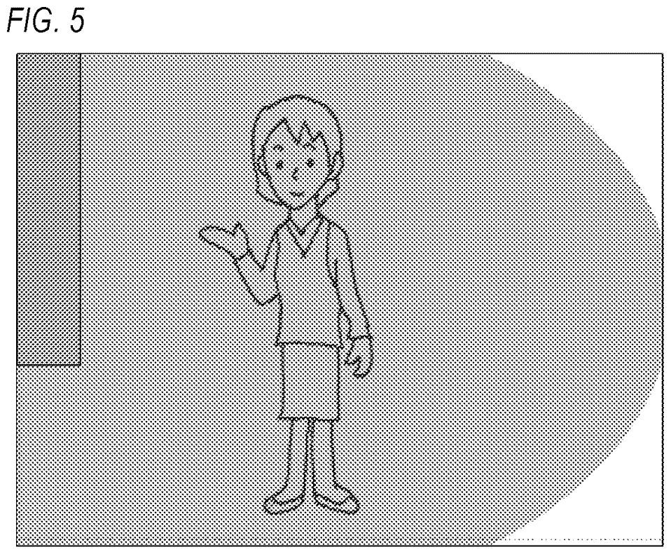

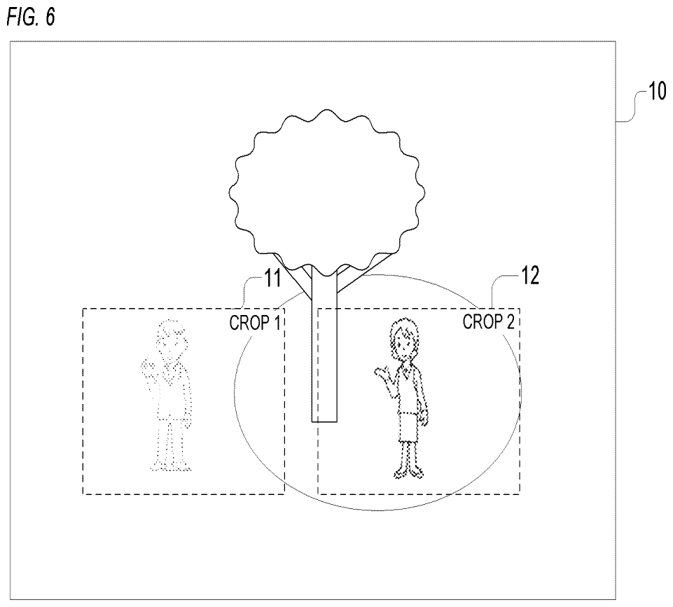

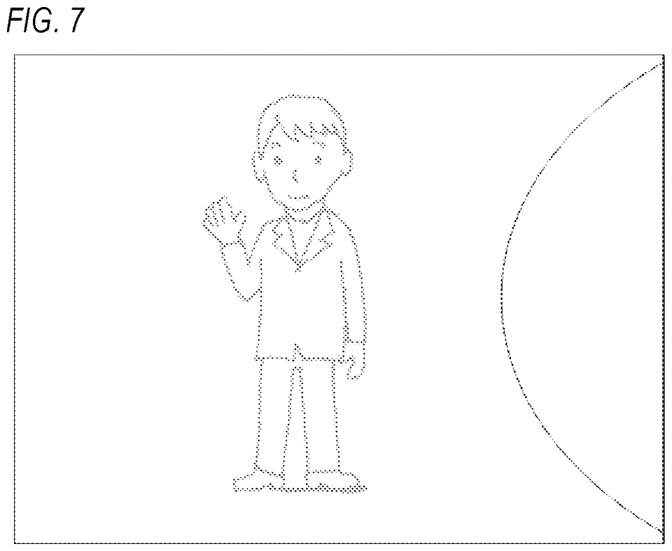

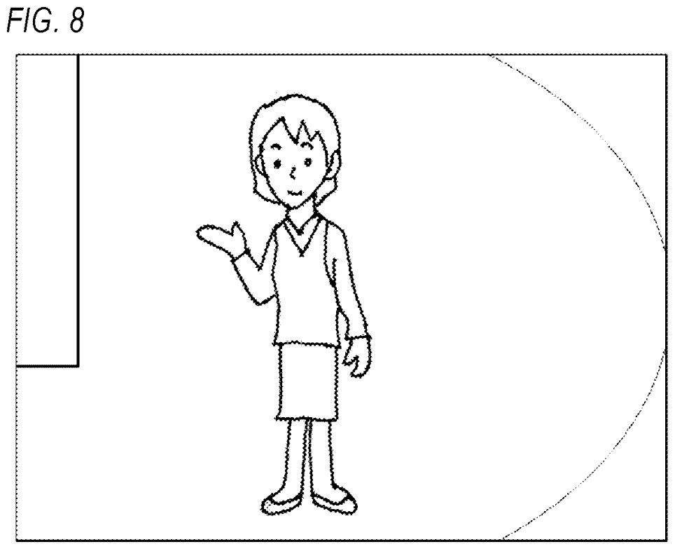

Next, an image adjustment method will be described. FIGS. 4 and 5 are images obtained by cutting out the image captured in FIG. 2 in areas of the crop 1 and the crop 2, respectively. In this case, exposure of the image of the crop 1 illustrated in FIG. 4 is appropriate, but exposure of the image of the crop 2 is under-exposure. FIG. 6 is an image captured by performing adjustment such that exposure of the crop 2 is appropriate. In this case, exposure of an image of the crop 2 illustrated in FIG. 8 is appropriate, but exposure of an image of the crop 1 illustrated in FIG. 7 is over-exposure.

When there is a contrast in a captured image in this manner, there is a case where exposure of the inside of an area cut out by cropping is not appropriate. In this case, it is necessary for a user to determine which exposure is to be adopted. Therefore, in the present embodiment, an exposure correction value is set for each crop area, and an area whose exposure is to be adopted is selected, whereby exposure correction intended by a user is performed.

First, a user performs setting of an exposure correction value for each crop area using the crop 1-selected exposure correction item 27 and the crop 2-selected exposure correction item 28. Next, an area to be an adjustment reference is designated in the adjustment reference area selection item 26. Adjustment information designated by the selection unit 210 is transmitted from the controller communication unit 220 to the camera communication unit 180. The camera communication unit 180 determines whether or not received information is the adjustment information, and transmits the adjustment information to the AE setting management unit 171.

The AE setting management unit 171 acquires an exposure correction value of a crop area corresponding to the transmitted adjustment reference area selection item, and transmits the exposure correction value to the AE unit 172. The AE unit 172 performs setting of a diaphragm, a shutter speed, and an ISO sensitivity of the lens 110 for the imaging unit 120 on the basis of the transmitted exposure correction value, and performs exposure correction. Such processing enables adjustment intended by the user.

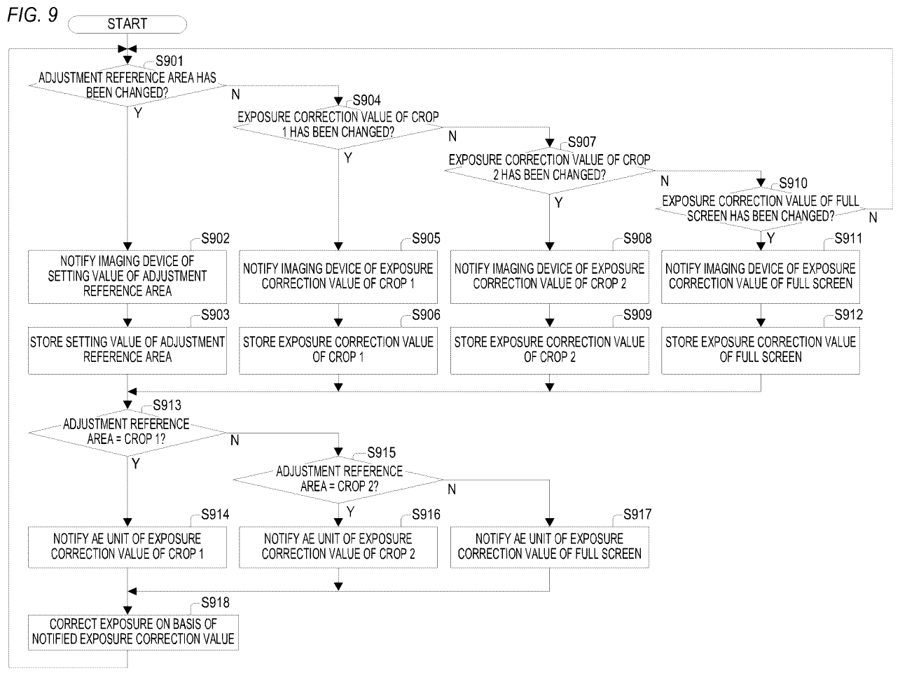

A series of control from when the user changes the setting to when the adjustment is applied can be implemented by applying processing as in a flowchart illustrated in FIG. 9. The flowchart of FIG. 9 will be described.

In S901, the controller device 2 monitors whether the adjustment reference area selection item 26 has been changed, and the process branches to S902 if there is a change after the previous execution of S901, and branches to S904 if there is no change. In S902, the controller device 2 notifies the AE setting management unit 171 of a changed value (new user setting value) of the adjustment reference area from the controller communication unit 220 via the camera communication unit 180 by the processing as described above. In S903, the AE setting management unit 171 stores the notified new user setting value of the adjustment reference area in a storage area (not illustrated), and the process proceeds to S913 described later.

In S904, the controller device 2 monitors whether the crop 1-selected exposure correction item 27 has been changed, and the process branches to S905 if there is a change after the previous execution of S904, and branches to S907 if there is no change. In S905, the controller device 2 notifies the AE setting management unit 171 of a changed value (new user setting value) of the exposure correction value of the crop 1 from the controller communication unit 220 via the camera communication unit 180 by the processing as described above. In S906, the AE setting management unit 171 stores the notified exposure correction value of the crop 1 in a storage area (not illustrated), and the process proceeds to S913 described later.

In S907 to S909, processing similar to S904 to S906 is performed on an exposure correction value at the time of selecting the crop 2. In addition, also in S910 to S912, processing similar to that in S904 to S906 is performed on an exposure correction value at the time of selecting a full screen. Note that, in the present embodiment, the exposure correction value at the time of selecting a full screen is set using a setting screen different from the crop setting screen 20 in FIG. 3. Note that, without being limited thereto, an item for setting an exposure correction value at the time of selecting a full screen may be added to the crop setting screen 20 in FIG. 3. If there is no change in S910, the process returns to S901.

In S913 and S915, the AE setting management unit 171 reads the setting value of the adjustment reference area from the storage area, and the process branches to S914 if the adjustment reference area is the crop 1, branches to S916 if the adjustment reference area is the crop 2, and branches to S917 if the adjustment reference area is a full screen. In S914, the AE setting management unit 171 reads the exposure correction value of the crop 1 from the storage area and notifies the AE unit 172 of the read exposure correction value. In S916, the AE setting management unit 171 reads the exposure correction value of the crop 2 from the storage area and notifies the AE unit 172 of the read exposure correction value. In S917, the AE setting management unit 171 reads the exposure correction value of the full screen from the storage area and notifies the AE unit 172 of the read exposure correction value.

In S918, the AE unit 172 performs exposure correction of the imaging unit 120 on the basis of the notified exposure correction value as described above. Thereafter, the process returns to S901. In this manner, exposure correction using an exposure correction value according to an adjustment reference area is applied to the imaging unit 120 every time setting is changed on the crop setting screen 20.

As described above, the imaging system according to the present embodiment can make intended exposure adjustment of a crop area appropriate only by a user selecting an adjustment reference area. Therefore, it is possible to provide an imaging system with excellent usability, the imaging system enabling a user to easily set desired adjustment.

Note that, in the present embodiment, a user sets an exposure correction value for each crop area using the crop 1-selected exposure correction item 27 and the crop 2-selected exposure correction item 28. However, instead of such manual setting, the imaging device 1 may automatically set an appropriate exposure correction value for each crop area. For example, by performing photometry only in a designated crop area, the imaging device 1 can calculate an appropriate exposure correction value for the crop area. Information regarding the crop area at the time of the automatic exposure correction can be acquired by transmitting information regarding the cutout size and position of the crop area from the crop area setting unit 150 to the adjustment unit 170.

In addition, before switching of the adjustment reference area, a function for confirming whether exposure in a switched area is as intended may be provided. For example, imaging is performed without changing exposure setting of the imaging unit 120. Then, the image processing unit 130 may perform image processing (brightness correction) on a taken image to create an adjustment result confirming image that simulates exposure correction after switching, and may output the image to a confirmation unit (not illustrated) or any output unit. A method for displaying the confirming image may be, for example, PinP display in which a small independent area is formed in an output image and the confirming imagen is displayed in the area.

In addition, there is a case where the imaging device 1 has a configuration (recording unit) capable of recording image data based on an original image captured by the imaging unit 120 on a built-in medium. In such a case, when an adjustment value of the imaging unit 120 is changed on the basis of the exposure correction value of the adjustment reference area during recording of image data, image data with inappropriate exposure may be recorded on the built-in medium. This is because the area of the image to be recorded on the built-in medium is not necessarily the same as the adjustment reference area of an output image output from an output unit, and thus an appropriate exposure correction amount may be different. Therefore, in order to prevent image data with inappropriate exposure from being recorded, preferably, the adjustment unit 170 does not perform adjustment of exposure of the imaging unit 120 based on the exposure correction value of the adjustment reference area during recording of the image data on the built-in medium. Furthermore, in this case, the adjustment unit 170 (AE unit 172) may perform adjustment of the exposure of the imaging unit 120 on the basis of an exposure correction value set in advance in a target area (may be a whole area or a crop area) to be recorded on the built-in medium. Note that an exposure correction value for a recording target area can also be preferably set by a user on a setting screen provided by the selection unit 210.

In addition, an exposure correction value used in actual adjustment may be determined by combining exposure correction values set for crop areas, respectively. For example, when a crop 1-selected exposure correction value is set to ±0 and a crop 2-selected exposure correction value is set to ±2 on the crop setting screen 20, weighted averaging may be performed at a ratio of, for example, 1:1, and an exposure correction value of ±1 (=±0/2±2/2) may be used for adjustment. The combination ratio (weight) is not limited to 1:1, and may be a fixed value or may be changeable. For example, an item for setting the combination ratio (weight for each crop area) may be added to the crop setting screen 20, and a user may arbitrarily set the composition ratio. In addition, the combination ratio may be adaptively (automatically) changed according to an area ratio, brightness ratio, or the like between crop areas.

In addition, in the present embodiment, exposure correction is a target, but hue correction such as white balance may be a target. In this case, in the image processing unit 130, a hue correction unit that applies hue correction to each of cut-out images is preferably included at a subsequent stage of the cutout unit 131. A plurality of types of hue correction parameters to be used for hue correction is preferably preset in the hue correction unit. The selection unit 210 preferably provides a user interface for designating a hue correction parameter such that a user selects a hue correction parameter for each crop area. As the hue correction parameter, for example, a parameter for correcting an influence of a color of light in an imaging environment, such as sunlight, shade, or a light bulb may be preset.

In addition, in the present embodiment, the configuration in which the selection unit 210 is included in the controller device 2 has been described, but the selection unit 210 may be included the imaging device 1 or a switcher device. That is, the imaging system may have a configuration in which the imaging device 1 and the controller device 2 are combined, a configuration in which the imaging device 1 and a switcher device are combined, or a configuration of the imaging device 1 alone.

### Second Embodiment

Hereinafter, a second embodiment of the present invention will be described.

In the adjustment method described in the first embodiment, exposure of an image of an area selected as an adjustment reference area is appropriate, but exposure of an image of an area other than the adjustment reference area may be inappropriate. In the second embodiment, the problem of the exposure of an area other than the adjustment reference area is reduced using image processing. In addition, in the present embodiment, processing of suppressing data loss such as blown-out highlights or blocked-up shadows of an image signal of a prioritized output unit by selecting which output unit is prioritized among a plurality of output units and performing adjustment of an imaging unit 120 on the basis of setting of the prioritized output unit will also be exemplified.

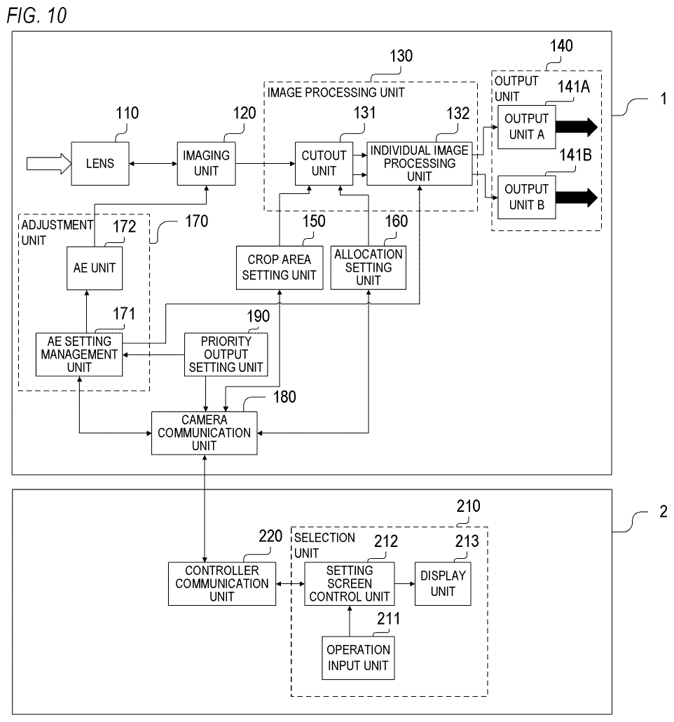

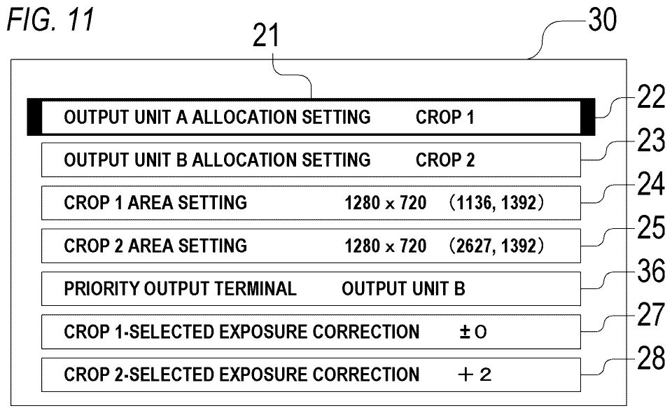

FIG. 10 is a diagram illustrating a configuration of an imaging system in the second embodiment. The imaging system in the second embodiment is different from the configuration of the first embodiment in including an individual image processing unit 132 and a priority output setting unit 190. In addition, the imaging system in the second embodiment is also different from the configuration of the first embodiment in that the crop setting screen displayed by the selection unit 210 of the controller device 2 is an operation screen as illustrated in FIG. 3 in the first embodiment, but an operation screen as illustrated in FIG. 11 is used in the second embodiment. Other components are similar to those of the first embodiment, and thus description thereof is omitted.

The individual image processing unit 132 individually performs image processing on each of image signals created by a cutout unit 131 and output to an output unit A141A and an output unit B141B. The priority output setting unit 190 controls a priority output terminal to be used in adjustment described later.

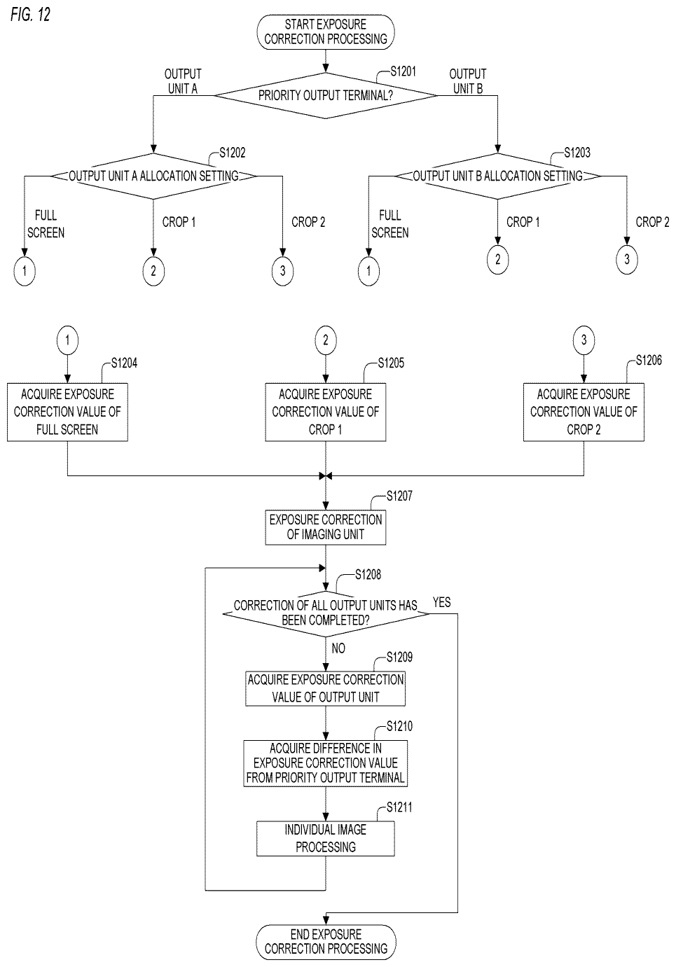

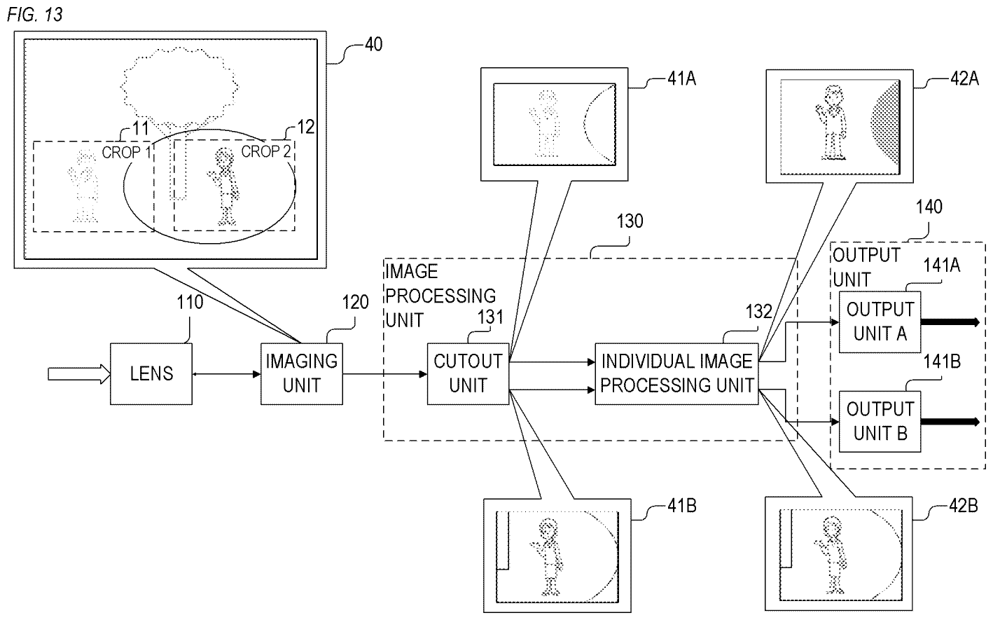

Exposure correction processing using the individual image processing unit 132 and the priority output setting unit 190 will be described with reference to FIGS. 11 to 13. FIG. 11 is a diagram illustrating an example of a crop setting screen displayed by the selection unit 210 of the controller device 2. FIG. 12 is a flowchart of the exposure correction processing. FIG. 13 is a diagram illustrating an exposure correction processing result in each block of an imaging device 1 when setting of a crop setting screen 30 illustrated in FIG. 11 is applied.

The crop setting screen 30 illustrated in FIG. 11 is similar to that of the first embodiment except that the adjustment reference area selection item 26 in the crop setting screen 20 in FIG. 3 is replaced with a priority output terminal item 36. The priority output terminal item 36 is an item for setting an output terminal to be preferentially adjusted such that an image signal is appropriate, and can select an output unit A or an output unit B. FIG. 11 illustrates a state in which the output unit B is set.

When an item on the crop setting screen 30 illustrated in FIG. 11 is changed, exposure correction processing illustrated in FIG. 12 is started. When the exposure correction processing is started, the controller device 2 first executes the following processing in order to acquire an exposure correction value allocated to a priority output terminal. In S1201, the controller device 2 acquires a value set in the priority output terminal item 36. If the output unit A is selected, the process proceeds to S1202, and if the output unit B is selected, the process proceeds to S1203. In S1202, the controller device 2 acquires a value set in an output-A allocation setting item 22 (that is, a setting value of an area to be output from an output terminal of the output unit A). The process proceeds to S1204 in a case of a full screen, the process proceeds to S1205 in a case of a crop 1, and the process proceeds to S1206 in a case of a crop 2. In S1203, the controller device 2 acquires a value set in an output-B allocation setting item 23 (that is, a setting value of an area to be output from an output terminal of the output unit B). Similarly, the process proceeds to S1204 in a case of a full screen, the process proceeds to S1205 in a case of a crop 1, and the process proceeds to S1206 in a case of a crop 2. An exposure correction value set for a full screen is acquired in S1204, an exposure correction value set for the crop 1 is acquired in S1205, and an exposure correction value set for the crop 2 is acquired in S1206. The exposure correction value thus acquired (exposure correction value allocated to the priority output terminal) is sent from the controller device 2 to the imaging device 1. Thereafter, the process proceeds to S1207.

Next, exposure correction is performed using the acquired exposure correction values allocated to the priority output terminal. In S1207, an adjustment unit 170 executes exposure correction processing on the imaging unit 120 on the basis of the exposure correction value allocated to the priority output terminal, acquired in S1204 to S1206. In a case of the setting example of the crop setting screen 30 illustrated in FIG. 11, the priority output terminal is “output unit B”, an area allocated thereto is “crop 2”, and an exposure correction value set in the area is +2. Therefore, the imaging unit 120 captures a plus-corrected image as indicated by reference numeral 40 in FIG. 13. The image captured by the imaging unit 120 is subjected to crop area cutout processing by the cutout unit 131, and an image 41A of the crop 1 area to be output to the output unit A141A and an image 41B of the crop 2 area to be output to the output unit B141B are transmitted to the individual image processing unit 132.

The individual image processing unit 132 performs the following individual processing on the images 41A and 41B to be output to the respective output units such that images with appropriate exposure are output from the respective output units. First, the image 41B in the crop 2 area allocated to the output unit B as the priority output terminal is an image cut out from an original image captured with appropriate exposure, and therefore is not subjected to individual image processing. On the other hand, the individual image processing unit 132 performs image processing based on an exposure correction amount for the crop 1 on the image 41A in the crop 1 area allocated to the output unit A other than the priority output terminal, and perform adjustment of exposure of the image 41A. At this time, the individual image processing unit 132 preferably performs adjustment of brightness of the image 41A such that brightness of the image 41A approaches brightness of an image captured in a state where exposure of the imaging unit 120 is adjusted on the basis of the exposure correction amount for the crop 1. That is, the individual image processing unit 132 simulates exposure adjustment of the imaging unit 120 by image processing (brightness adjustment). Note that it is only required to determine (calculate) brightness adjustment amount for the image 41A on the basis of an exposure correction amount applied to the exposure adjustment of the imaging unit 120 (exposure correction amount for the crop 2 area) and an exposure correction amount for the area of the image 41A (exposure correction amount for the crop 1 area). Hereinafter, a specific processing example will be described.

First, in S1208, the individual image processing unit 132 determines whether correction of images to be output to all the output units has been completed. If the correction has not been completed, the process proceeds to S1209, and if the correction has been completed, the individual image processing is terminated.

In S1209, the individual image processing unit 132 acquires an exposure correction value allocated to an output unit of an individual image processing target from allocation setting information and crop-selected exposure correction information of the output unit. In S1210, the individual image processing unit 132 acquires a difference between the “exposure correction value of the output unit” acquired in S1209 and the “exposure correction value allocated to the priority output terminal”. For example, in a case of the output unit A, since the exposure correction value of the output unit A is +0 and the exposure correction value of the output unit B allocated to the priority output terminal is +2, 0−2=−2 is acquired as the difference.

In S1211, the individual image processing unit 132 corrects exposure by image processing on the basis of the difference acquired in S1210. For example, in a case of the output unit A, brightness correction of −2 is performed on the image 41A input to the individual image processing unit 132 by image processing, and an image such as a reference numeral 42A is generated. On the other hand, in a case of the output unit B, since the difference between the exposure correction values is 0, brightness correction is not performed by the individual image processing unit 132, and the input image 41B is directly output as the image 42B. When the individual image processing is completed, the process proceeds to S1208, and the processing of S1209 to S1211 is repeated until the correction of all the output units is completed.

By performing the exposure correction as described above, exposure adjustment is performed such that the image of the output unit designated by the priority output terminal is captured with appropriate exposure, and an image in which a deviation from appropriate exposure is reduced by image processing can be output for an image of an output unit other than the designated output unit.

For example, it is assumed that the output unit A is connected to a device used for recording and distribution of an image, and the output unit B is connected to a device used for preview of an image to which switching is performed next. In this case, by setting the priority output terminal to the output unit A, it is possible to preferentially adjust an image used for recording and distribution of an image. In addition, by using priority output terminal setting, switching processing of a crop area and adjustment processing accompanying a change of the crop area can be performed in synchronization. In addition, an option may be added to the priority output terminal item 36, and the adjustment processing may be performed on the basis of an area recorded by a recording unit (not illustrated).

Note that, in the present embodiment, the exposure correction processing is performed using both the imaging unit 120 and the individual image processing unit 132 in order to prevent data loss due to blown-out highlights or blocked-up shadows of an imaging signal obtained by the imaging unit 120, but the exposure correction processing may be performed only by the individual image processing unit 132.

In addition, in order to prevent an exposure change of image data to be recorded during recording on a built-in medium, it is preferable not to perform adjustment of exposure of the imaging unit 120 by the adjustment unit 170. In addition, in this case, the adjustment unit 170 may perform adjustment of the exposure of the imaging unit 120 on the basis of an exposure correction value set in advance in an area to be recorded on the built-in medium. Furthermore, control may be performed so as to perform exposure correction processing by brightness adjustment on an output image using only the individual image processing unit 132.

### Third Embodiment

Hereinafter, a third embodiment of the present invention will be described.

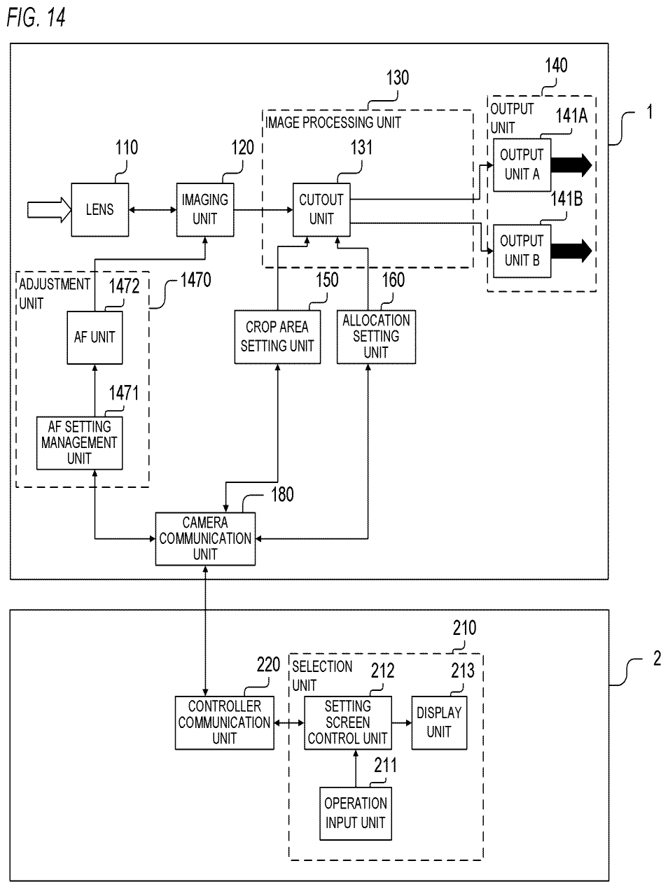

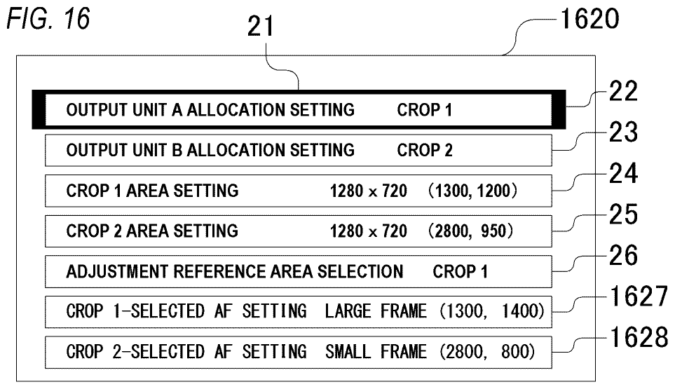

The imaging systems of the first and second embodiments are directed to exposure adjustment, but an imaging system of the third embodiment is directed to autofocus adjustment. FIG. 14 is a diagram illustrating a configuration of the imaging system in the third embodiment. The configuration of the imaging system in the third embodiment is different from that of the first embodiment in that the adjustment unit 170 in the first embodiment is replaced with an adjustment unit 1470. In addition, the configuration of the imaging system in the third embodiment is also different from that of the first embodiment in that the crop setting screen displayed by the selection unit 210 of the controller device 2 is an operation screen as illustrated in FIG. 3 in the first embodiment, but an operation screen as illustrated in FIG. 16 is used in the third embodiment. Other components are similar to those of the first embodiment, and thus description thereof is omitted.

The adjustment unit 1470 performs control such as management and adjustment of various parameter settings related to autofocus in a lens 110. The adjustment unit 1470 includes an AF setting management unit 1471 and an AF unit 1472.

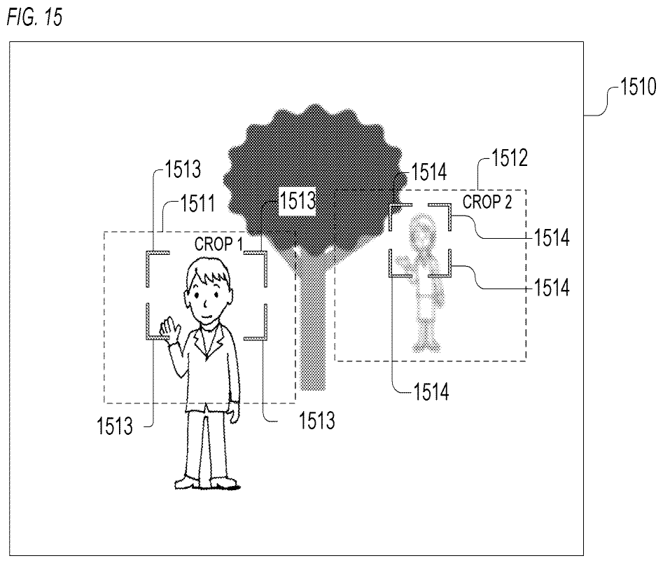

Next, crop processing in the third embodiment will be described. FIG. 15 illustrates an example of an image captured by an imaging device 1, and FIG. 16 is a diagram illustrating an example of a crop setting screen displayed by a selection unit 210 of a controller device 2.

In FIG. 15, as in FIG. 2 of the first embodiment, a solid line 1510 indicates a full-screen area imaged by the imaging unit 120, and broken lines 1511 and 1512 indicate areas of a crop 1 and a crop 2, respectively. Any cutout size and position can be designated by the selection unit 210 of the controller device 2. Frames 1513 and 1514 represent AF frames for the crop 1 and the crop 2, respectively, and are adjusted such that an object in each of the frames is in focus in autofocus. Since a known method can be used as a method for adjusting autofocus itself, description thereof is omitted.

As in FIG. 3 of the first embodiment, a crop setting screen 1620 illustrated in FIG. 16 is a screen for performing various settings related to cropping. Those denoted by the same reference numerals as those in FIG. 3 have the same contents, and thus description thereof is omitted. Note that, in the example of FIG. 16, the size of the crop 1 is 1280×720 and the position of center coordinates thereof is (1300, 1200), and the size of the crop 2 is 1280×720 and the position of center coordinates thereof is (2800, 950). A difference from the items in FIG. 3 is that the crop 1-selected exposure correction item 27 and the crop 2-selected exposure correction item 28 are replaced with a crop 1-selected AF setting item 1627 and a crop 2-selected AF setting item 1628, respectively. The crop 1-selected AF setting item 1627 and the crop 2-selected AF setting item 1628 are settings for autofocus to be applied when the crop 1 and the crop 2 are selected, respectively. Whether to actually apply the settings depends on setting of an adjustment reference area selection item 26. In the present embodiment, an AF setting value includes information designating the size and position of an AF frame. Specifically, any one of the entire crop, a large frame, and a small frame can be selected as the size of the AF frame, and center coordinates can be set as the position of the AF frame. In FIG. 16, as crop 1-selected AF setting, the frame size is set to a large frame, and the position of the center coordinates is set to (1300, 1400), and as crop 2-selected AF setting, the frame size is set to a small frame, and the position of the center coordinates is set to (2800, 800). The item of the AF setting is merely an example, and for example, setting of whether to intermittently execute autofocus or execute autofocus only once, and enabling/disabling of setting to recognize a face and follow the face may be added.

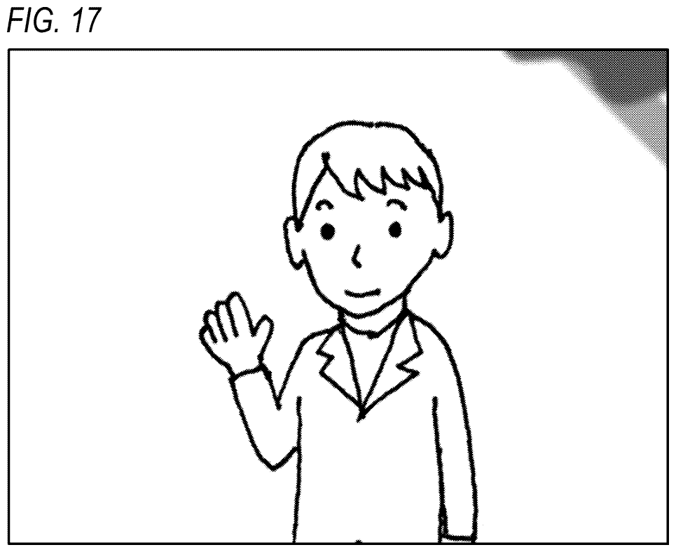

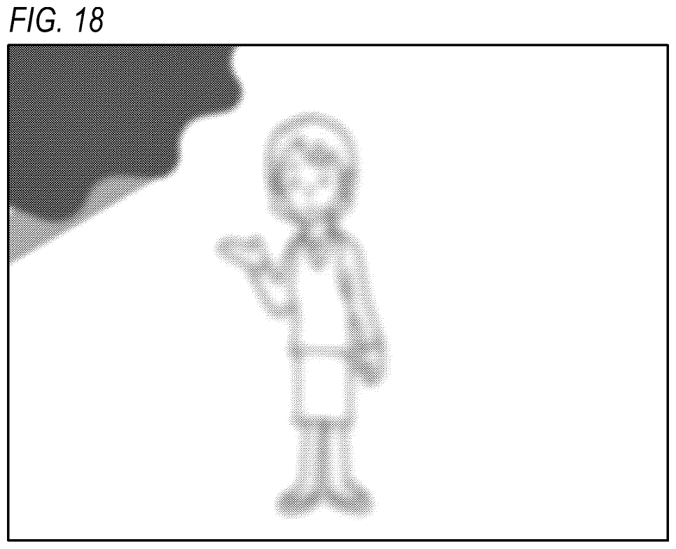

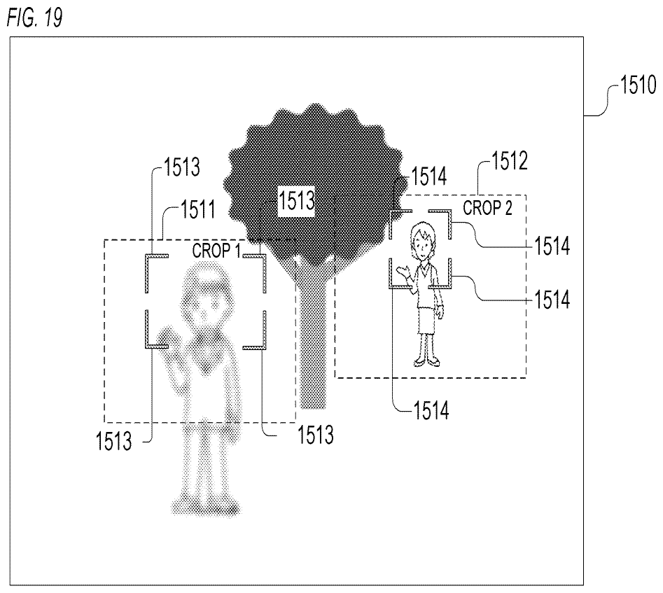

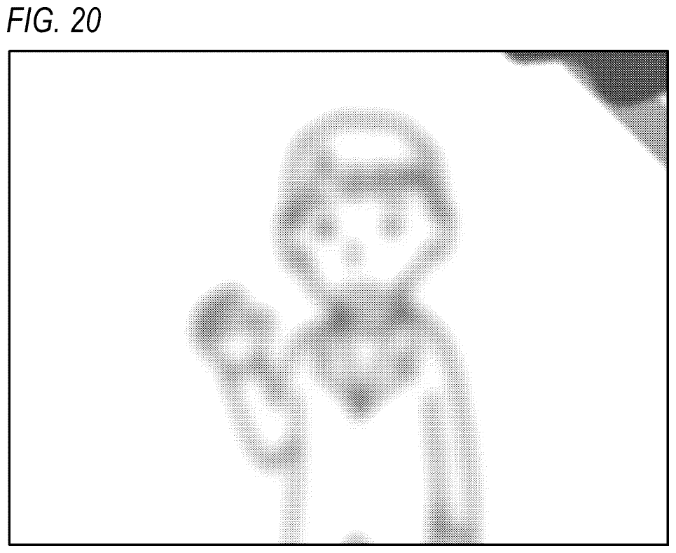

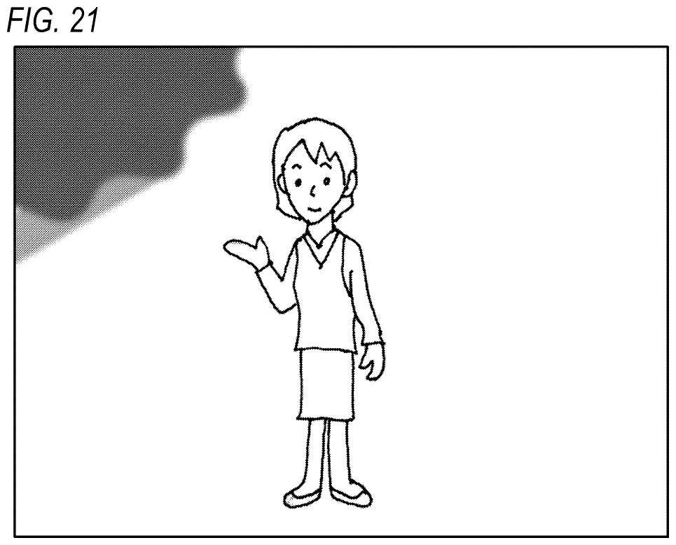

Next, an image adjustment method will be described. FIGS. 17 and 18 are images obtained by cutting out the image of FIG. 15 in areas of the crop 1 and the crop 2, respectively. In this case, focus of an image of the crop 1 illustrated in FIG. 17 is appropriate, but focus of an image of the crop 2 illustrated in FIG. 18 is blurred. FIG. 19 is an image captured by adjusting the focus of an image of the crop 2 to be appropriate. In this case, focus of an image of the crop 2 illustrated in FIG. 21 is appropriate, but focus of an image of the crop 1 illustrated in FIG. 20 is blurred.

As illustrated in FIGS. 15 and 19, when there is a distance difference between a plurality of objects in a captured image, there is a case where an object in an area cut out by cropping is not in appropriate focus. In this case, it is necessary for a user to determine which object is brought into focus. Therefore, in the present embodiment, a focus setting value is held for each crop area, and an area to be brought into focus is selected, whereby focus adjustment intended by a user is performed.

First, a user performs setting of the frame size and position of AF setting for each crop area using the crop 1-selected AF setting item 1627 and the crop 2-selected AF setting item 1628. Next, a crop area to be an adjustment reference area is designated in the adjustment reference area selection item 26. Setting information designated by the selection unit 210 is transmitted from a controller communication unit 220 to the AF setting management unit 1471 via a camera communication unit 180 similarly to the exposure adjustment information of the first embodiment.

The AF setting management unit 1471 acquires an AF setting value of the crop area designated as the adjustment reference area and transmits the acquired AF setting value to the AF unit 1472. The AF unit 1472 performs adjustment on the lens 110 such that an object is in focus using imaging information of the imaging unit 120 or a distance measurement sensor value (not illustrated) on the basis of the transmitted AF setting value. Such processing enables focus adjustment based on AF setting intended by the user.

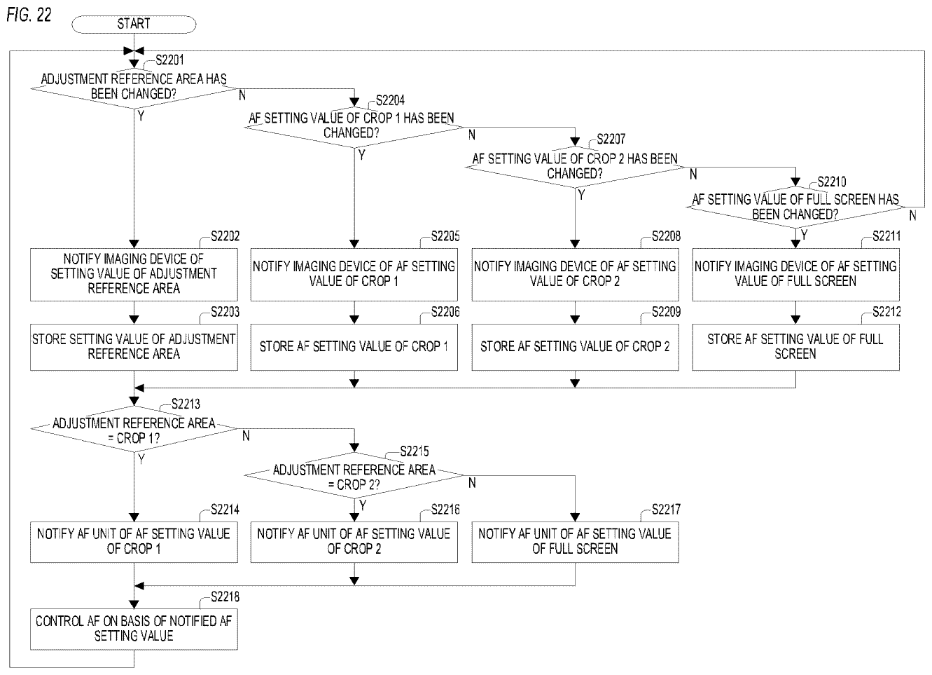

A series of control from when the user changes the setting to when the adjustment is applied can be implemented by applying processing as in a flowchart illustrated in FIG. 22. The flowchart of FIG. 22 will be described.

In S2201, the controller device 2 monitors whether the adjustment reference area selection item 26 has been changed, and the process branches to S2202 if there is a change after the previous execution of S2201, and branches to S2204 if there is no change. In S2202, the controller device 2 notifies the AF setting management unit 1471 of a changed value (new user setting value) of an adjustment reference area from the controller communication unit 220 via the camera communication unit 180 by the processing as described above. In S2203, the AF setting management unit 1471 stores the notified new user setting value of the adjustment reference area in a storage area (not illustrated), and the process proceeds to S2213 described later.

In S2204, the controller device 2 monitors whether the crop 1-selected AF setting item 1627 has been changed, and the process branches to S2205 if there is a change after the previous execution of S2204, and branches to S2207 if there is no change. In S2205, the controller device 2 notifies the AF setting management unit 1471 of a changed value (new user setting value) of the AF setting value of the crop 1 from the controller communication unit 220 via the camera communication unit 180 by the processing as described above. In S2206, the AF setting management unit 1471 stores the notified AF setting value of the crop 1 in a storage area (not illustrated), and the process proceeds to S2213 described later.

In S2207 to S2209, processing similar to S2204 to S2206 is performed on an AF setting value at the time of selecting the crop 2. In addition, also in S2210 to S2212, processing similar to that in S2204 to S2206 is performed on an AF setting value at the time of selecting a full screen. Note that, in the present embodiment, the AF setting value at the time of selecting a full screen is set using a setting screen different from the crop setting screen 1620 in FIG. 16. Note that, without being limited thereto, an item for setting an AF setting value at the time of selecting a full screen may be added to the crop setting screen 1620 in FIG. 16. If there is no change in S2210, the process returns to S2201.

In S2213 and S2215, the AF setting management unit 1471 reads the setting value of the adjustment reference area from the storage area, and the process branches to S2214 if the adjustment reference area is the crop 1, branches to S2216 if the adjustment reference area is the crop 2, and branches to S2217 if the adjustment reference area is a full screen. In S2214, the AF setting management unit 1471 reads the AF setting value of the crop 1 from the storage area and notifies the AF unit 1472 of the read AF setting value. In S2216, the AF setting management unit 1471 reads the AF setting value of the crop 2 from the storage area and notifies the AF unit 1472 of the read AF setting value. In S2217, the AF setting management unit 1471 reads the AF setting value of the full screen from the storage area and notifies the AF unit 1472 of the read AF setting value.

In S2218, the AF unit 1472 performs autofocus adjustment on the lens 110 on the basis of the notified AF setting value as described above. Thereafter, the process returns to S2201. In this manner, autofocus adjustment using an AF setting value according to an adjustment reference area is applied to the lens 110 every time setting is changed on the crop setting screen 1620.

Note that, in the present embodiment, a user sets an AF setting value for each crop area using the crop 1-selected AF setting item 1627 and the crop 2-selected AF setting item 1628. However, instead of such manual setting, the imaging device 1 may execute autofocus using imaging information for each crop area. Information regarding the crop area at the time of the autofocus can be acquired by transmitting information regarding the cutout size and position of the crop area from the crop area setting unit 150 to the adjustment unit 1470. In addition, in order to simplify the description, the configuration is similar to that of the first embodiment, but as illustrated in FIG. 10 of the second embodiment, the priority output setting unit 190 may be added such that an output image of a terminal set to the priority output terminal is in appropriate focus all the time.

In addition, when the adjustment value of the lens 110 is changed on the basis of the AF setting value of the adjustment reference area during recording on a built-in medium, image data in inappropriate focus may be recorded on the built-in medium. This is because the area of the image to be recorded on the built-in medium is not necessarily the same as the adjustment reference area of an output image output from an output unit, and thus an appropriate AF setting value may be different. Therefore, in order to prevent image data in inappropriate focus from being recorded, preferably, the adjustment unit 1470 does not perform adjustment of focus based on the AF setting value of the adjustment reference area during recording of the image data on the built-in medium. Furthermore, in this case, the adjustment unit 1470 (AF unit 1472) may perform adjustment of focus on the basis of an AF setting value set in advance in a target area (may be a whole area or a crop area) to be recorded on the built-in medium. Note that an AF setting value for a recording target area can also be preferably set by a user on a setting screen provided by the selection unit 210.

In addition, in the present embodiment, the configuration in which the selection unit 210 is included in the controller device 2 has been described, but the selection unit 210 may be included the imaging device 1 or a switcher device. That is, the imaging system may have a configuration in which the imaging device 1 and the controller device 2 are combined, a configuration in which the imaging device 1 and a switcher device are combined, or a configuration of the imaging device 1 alone.

### Fourth Embodiment

Hereinafter, a fourth embodiment of the present invention will be described.

The imaging systems of the first and second embodiments are directed to only exposure adjustment, and the imaging system of the third embodiment is directed to only autofocus adjustment, but an imaging system of the fourth embodiment is directed to both exposure adjustment and autofocus adjustment. When an adjustment reference area is changed in this configuration, an execution timing of automatic adjustment for each of the exposure adjustment and the autofocus adjustment is preferably determined such that autofocus is not executed in an inappropriate exposure adjustment state. This will be described in the present embodiment.

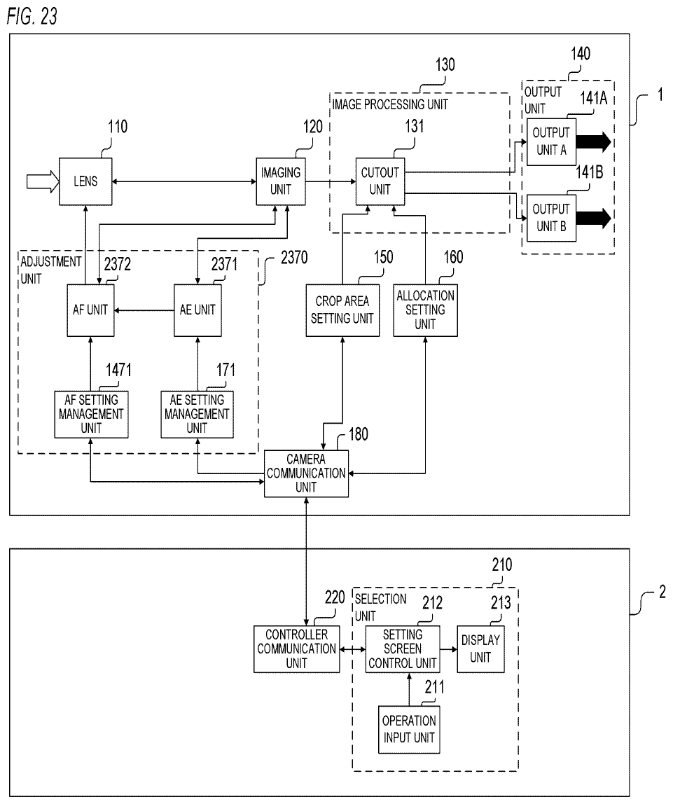

FIG. 23 is a diagram illustrating a configuration of the imaging system in the fourth embodiment. A configuration of an adjustment unit 2370 is different from those of FIG. 1 of the first embodiment and FIG. 14 of the third embodiment. The adjustment unit 2370 includes an AE setting management unit 171, an AE unit 2371, an AF setting management unit 1471, and an AF unit 2372. Since components other than the AE unit 2371 and the AF unit 2372 are similar to those in the first embodiment or the third embodiment, description thereof is omitted. The AE unit 2371 has an additional function of executing processing of notifying the AF unit 2372 whether exposure adjustment executed after an adjustment reference area is changed is completed as compared with the AE unit 172 of the first embodiment. The AF unit 2372 has an additional function of performing control so as not to execute autofocus adjustment until exposure adjustment is completed in a case where an adjustment reference area is changed as compared with the AF unit 1472 of the third embodiment. Hereinafter, a detailed processing flow will be described.

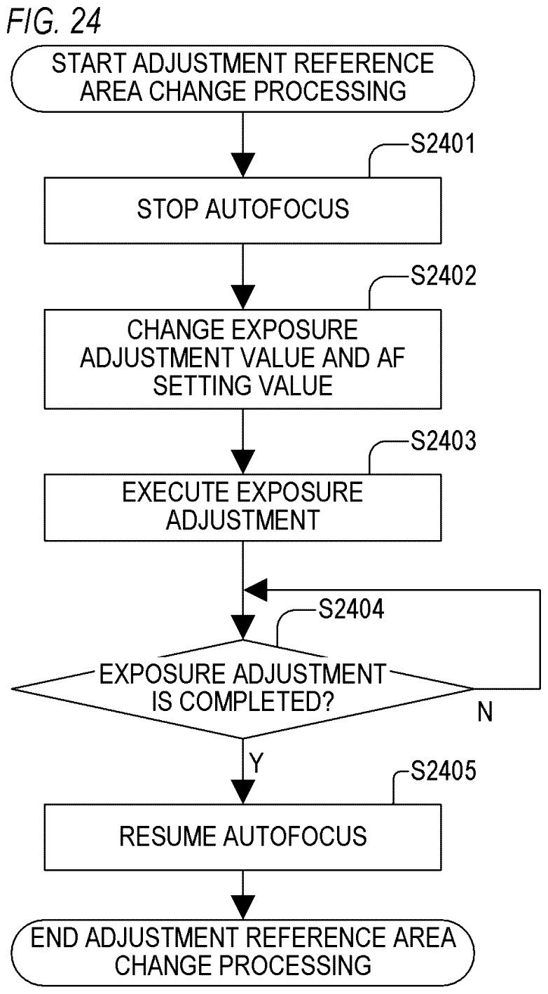

FIG. 24 is a flowchart of processing performed by the adjustment unit 2370 when an adjustment reference area is changed. Note that it is assumed that autofocus processing is executed by the AF unit 2372 all the time before processing of FIG. 24 is started (that is, in a normal state).

In S2401, the AF unit 2372 stops an autofocus function. In S2402, an exposure adjustment value of which the AE unit 2371 is notified from the AE setting management unit 171 and an AF setting value of which the AF unit 2372 is notified from the AF setting management unit 1471 are changed to those of a new crop area. In S2403, the AE unit 2371 executes exposure adjustment with an exposure adjustment value of the new crop area. In S2404, it is waited until the exposure adjustment is completed, and the process proceeds to S2405 when the exposure adjustment is completed. In S2405, the AF unit 2372 starts an autofocus function with the AF setting value of the new crop area.

By performing the control as described above, it is possible to avoid an error caused by execution of autofocus in an inappropriate exposure adjustment state. Note that a modification similar to the third embodiment is possible.

### Fifth Embodiment

Hereinafter, a fifth embodiment of the present invention will be described. The third embodiment is an example of an imaging system having a configuration including an imaging device and a controller device, but the fifth embodiment is an example of a case where an imaging system includes an imaging device alone.

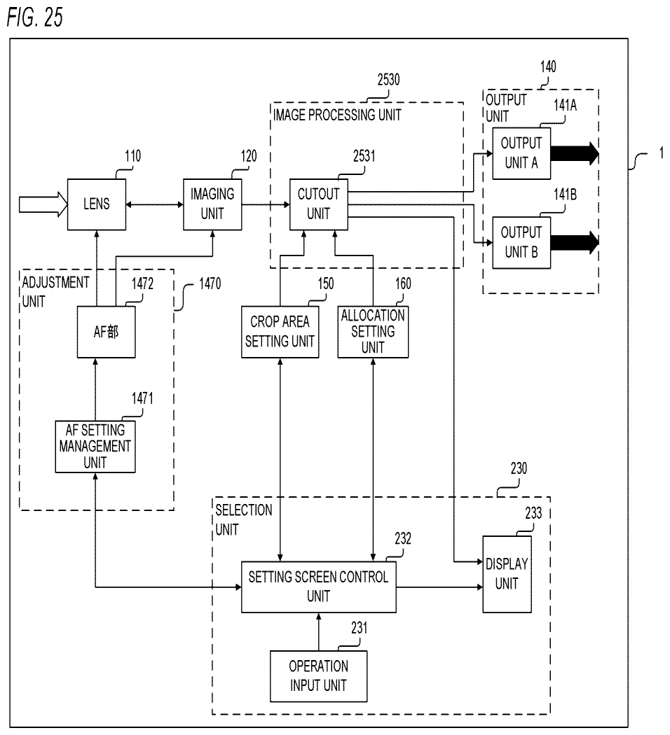

FIG. 25 is a diagram illustrating a configuration of an imaging device 1 in the fifth embodiment. A difference from the imaging device 1 of FIG. 14 of the third embodiment is that the camera communication unit 180 is eliminated, a selection unit 230 is added, and an internal configuration of an image processing unit 2530 is changed. The selection unit 230 includes an operation input unit 231, a setting screen control unit 232, and a display unit 233. Since components other than these components are similar to those in the third embodiment, description thereof is omitted.

A cutout unit 2531 is similar to the cutout unit 131 in that an image signal obtained by cutting out any area from a captured image can be generated, but is different from the cutout unit 131 in that an output destination is not only an output unit 140 but also a display unit 233 described later. An image output to the display unit 233 can also be selected from the entire area, a crop 1 area, and a crop 2 area. The operation input unit 231 is an interface that receives an operation from a user, and includes, for example, an operation member such as a keypad or a touch panel. The setting screen control unit 232 creates a screen for receiving setting to be presented to the user, determines what setting has been made, and notifies a crop area setting unit 150, an allocation setting unit 160, and an AF setting management unit 1471 of a new user setting value according to the set contents. The display unit 233 superimposes the setting screen generated by the setting screen control unit 232 on the image output from the cutout unit 2531, and displays the superimposed image. The display unit 233 and the operation input unit 231 may be constituted by a touch panel display.

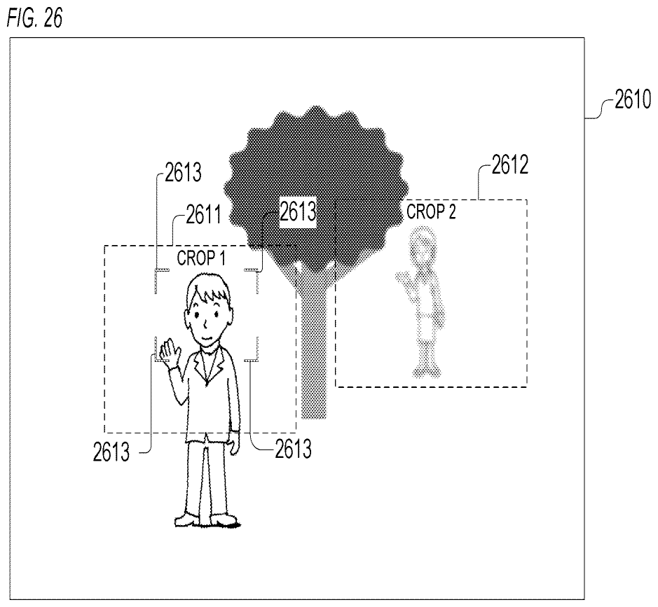

Next, crop processing in the fifth embodiment will be described. Similarly to the third embodiment, the selection unit 230 can display a crop setting screen as illustrated in FIG. 16, and a user performs an operation of crop setting on this screen. FIG. 26 illustrates an example of an image captured by the imaging device 1, a solid line 2610 indicates a full-screen area imaged by an imaging unit 120, and broken lines 2611 and 2612 indicate areas of the crop 1 and the crop 2, respectively. The used can designate any cutout size and position with the selection unit 230. A frame 2613 represents an active AF frame, and is adjusted such that an object in the frame is in focus in autofocus. Note that a setting value of the AF frame of the area set in the adjustment reference area selection item 26 is used as the active AF frame 2613. The crop setting screen 1620 is displayed by pressing a menu key (not illustrated) or the like, and performs setting of each item by a touch operation, a cross key (not illustrated), or the like. An output unit A allocation setting item 22 to an adjustment reference area selection item 26 can be input or selected by a keypad, a touch operation, or the like.

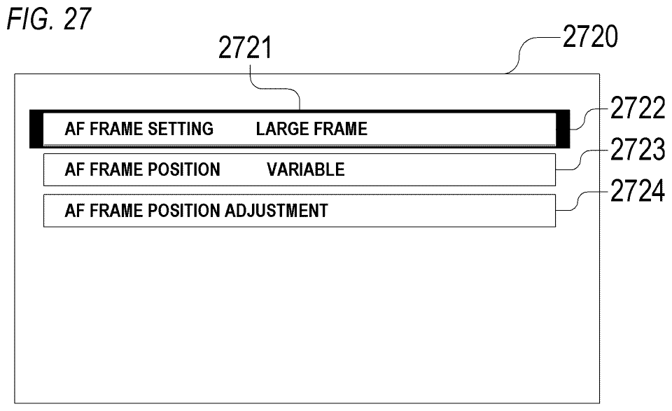

A flow of setting of a crop 1-selected AF setting item 1627 and a crop 2-selected AF setting item 1628 will be described with reference to FIGS. 27 to 29.

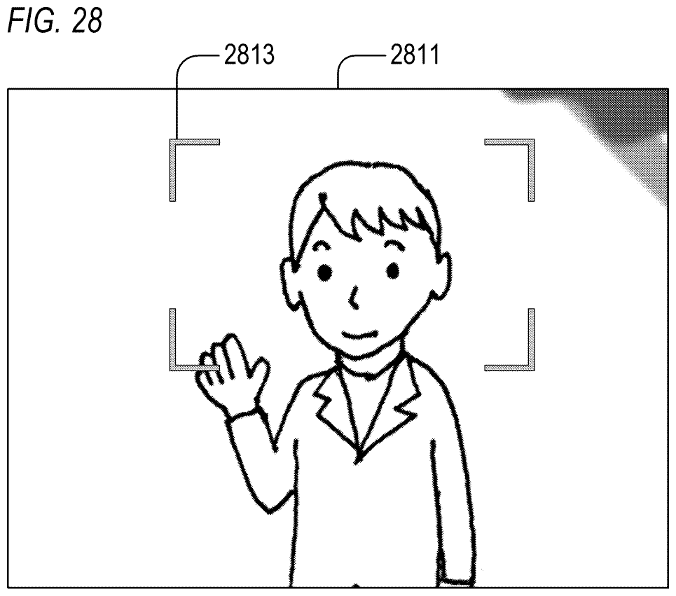

FIG. 27 is a crop 1-selected AF setting screen 2720. When the crop 1-selected AF setting item 1627 on the crop setting screen 1620 in FIG. 16 is selected, the screen transitions to the crop 1-selected AF setting screen 2720. The crop 1-selected AF setting screen 2720 includes a menu cursor 2721 representing a currently selected item, an AF frame setting item 2722, an AF frame position item 2723, and an AF frame position adjustment item 2724. The AF frame setting item 2722 is an item for determining the size of an AF frame to be an AF target area, and is selected from the entire crop 1, a large frame, and a small frame. The AF frame position item 2723 is an item for determining the center position of the AF frame, and is selected from a crop center and variable. The AF frame position adjustment item 2724 is setting for adjusting the center position in a case where the AF frame position is variable, and when this item is touched, the screen transitions to an AF frame position adjustment screen of FIG. 28. The AF frame position adjustment screen includes a crop 1 area cutout image 2811 and a crop 1 AF frame 2813. At present, since the adjustment reference area is set to the crop 1, the crop 1 AF frame 2813 is active, and AF adjustment is performed such that a male's face present in this frame is in focus. A user can move the crop 1 AF frame 2813 by touching any place in the screen. In addition, since the crop 1 AF frame 2813 is active at present, AF is executed in the area after the movement.

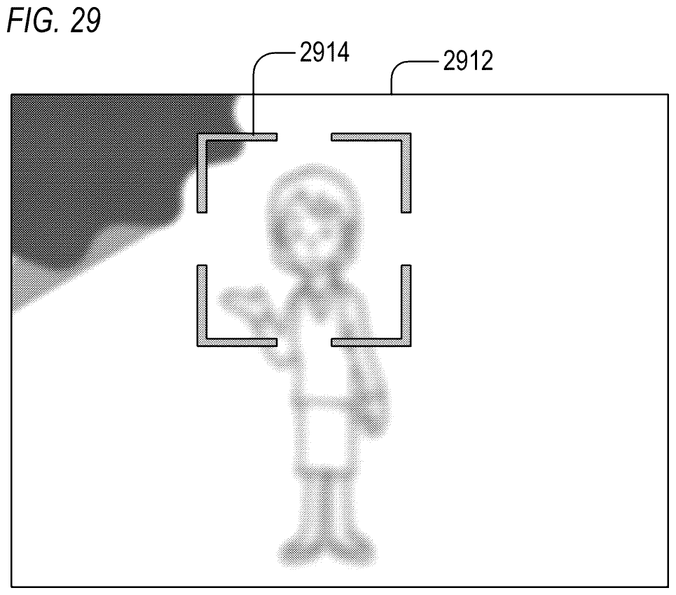

On the other hand, regarding the crop 2, although not illustrated, a crop 2-selected AF setting screen is prepared. When the crop 2-selected AF setting item 1628 on the crop setting screen 1620 is selected, the screen transitions to the crop 2-selected AF setting screen. Similarly, when the AF frame position adjustment is touched in a state where the AF frame position is variable, the screen transitions to the AF frame position adjustment screen of FIG. 29. FIG. 29 includes a crop 2 area cutout image 2912 and a crop 2 AF frame 2914. At present, since the adjustment reference area is set to the crop 1, the crop 2 AF frame 2914 is not active, and AF for a woman in the frame is not performed. The user can move the crop 2 AF frame 2914 by touching any place in this screen. At present, the crop 2 AF frame 2914 is not active, but when the adjustment reference area is changed to the crop 2, the crop 2 AF frame 2914 immediately becomes active, and AF is executed in the area. Note that the active AF frame 2813 and the inactive AF frame 2914 may be different from each other in color, line, shape, and the like such that the active AF frame 2813 and the inactive AF frame 2914 can be visually distinguished from each other.

As described above, the present invention can also be implemented by an imaging device alone. Note that, also in the case of the configuration of the imaging device alone, similar modifications to the first to fourth embodiments are possible.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present invention are also included in the present invention. The present invention also includes other configurations obtained by suitably combining various features of the embodiment.

The present invention can provide an imaging system with excellent usability, the imaging system enabling a user to easily set desired adjustment.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-001978, filed on Jan. 10, 2024, which is hereby incorporated by reference herein in its entirety.

What is claimed is:

1. An imaging system comprising:
an image sensor;
a plurality of output interfaces capable of outputting an output image to an outside on a basis of an original image captured by the image sensor;
one or more processors; and
one or more memories storing one or more programs which, when executed by the one or more processors, cause the imaging system to
execute first setting processing of setting areas of a plurality of output images respectively output from the plurality of output interfaces from the original image, the first setting processing being capable of setting mutually different areas as the areas of the plurality of output images,
execute second setting processing of individually setting a setting value for each of the areas of the plurality of output images, and
execute adjustment processing of performing adjustment of entire of the original image using the setting value set for a first area among the areas of the plurality of output images.

2. The imaging system according to claim 1, wherein
the one or more programs, when executed by the one or more processors, further cause the imaging system to execute selection processing of causing a user to select the first area from among the areas of the plurality of output images.

3. The imaging system according to claim 1, wherein
the one or more programs, when executed by the one or more processors, further cause the imaging system to execute selection processing of causing a user to select a first output interface from among the plurality of output interfaces, and
the first area is an area of an output image output from the first output interface selected by the user.

4. The imaging system according to claim 1, wherein
the setting value includes an exposure correction value used for adjusting exposure, and
in the adjustment processing, adjustment of exposure of the image sensor is performed using a first exposure correction value set for the first area.

5. The imaging system according to claim 4, wherein
in the adjustment processing, adjustment of exposure at a time of capturing the original image by the image sensor is performed by performing adjustment of one or more of a diaphragm, a shutter speed, and an ISO sensitivity for the image sensor on a basis of the first exposure correction value.

6. The imaging system according to claim 5, wherein
the one or more programs, when executed by the one or more processors, further cause the imaging system to execute image processing of performing adjustment of exposure of an output image of a second area different from the first area among areas of the plurality of output images by performing image processing on an image in the second area on a basis of a second exposure correction value set for the second area.

7. The imaging system according to claim 6, wherein
in the image processing, brightness adjustment of an image in the second area is performed such that brightness of an output image of the second area approaches brightness of an image captured in a case where exposure of the image sensor is adjusted by the adjustment processing on a basis of the second exposure correction value.

8. The imaging system according to claim 7, wherein
in the image processing, brightness adjustment amount for an image in the second area is determined on a basis of the first exposure correction value and the second exposure correction value.

9. The imaging system according to claim 6, wherein
in the image processing, an image for confirming an adjustment result is generated by performing image processing based on the first exposure correction value on an original image captured by the image sensor before adjustment for the image sensor is performed on a basis of the first exposure correction value in the adjustment processing.

10. The imaging system according to claim 4, wherein
the one or more programs, when executed by the one or more processors, further cause the imaging system to execute recording processing of recording image data based on an original image captured by the image sensor on a medium, and
in the adjustment processing, during recording of the image data by the recording processing, adjustment of exposure of the image sensor based on the first exposure correction value is not performed.

11. The imaging system according to claim 10, wherein
in the adjustment processing, in a case where image data in a third area in the original image is recorded on the medium in the recording processing, adjustment of exposure of the image sensor is performed on a basis of a third exposure correction value set in advance for the third area.

12. The imaging system according to claim 1, wherein
the setting value includes an AF setting value used for adjusting autofocus, and
in the adjustment processing, adjustment of autofocus of the image sensor is performed using a first AF setting value set for the first area.

13. The imaging system according to claim 12, wherein
the AF setting value includes information designating a size and position of an AF frame.

14. The imaging system according to claim 12, wherein
the one or more programs, when executed by the one or more processors, further cause the imaging system to execute recording processing of recording image data based on an original image captured by the image sensor on a medium, and
in the adjustment processing, during recording of the image data by the recording processing, adjustment of autofocus of the image sensor based on the first AF setting value is not performed.

15. The imaging system according to claim 14, wherein
in the adjustment processing, in a case where image data in a third area in the original image is recorded on the medium in the recording processing, adjustment of autofocus of the image sensor is performed on a basis of an AF setting value set in advance for the third area.

16. The imaging system according to claim 1, wherein
the setting value includes an exposure correction value used for adjustment of exposure and an AF setting value used for adjustment of autofocus, and
in the adjustment processing, adjustment of exposure of the image sensor is performed using a first exposure correction value set for the first area, and adjustment of autofocus of the image sensor is performed using a first AF setting value set for the first area.

17. The imaging system according to claim 16, wherein
in the adjustment processing, adjustment of exposure based on the first exposure correction value is performed after autofocus of the image sensor is stopped, and autofocus is resumed using the first AF setting value after the adjustment of the exposure is completed.

18. The imaging system according to claim 1, wherein
the setting value includes a hue correction parameter used to correct a hue, and
the one or more programs, when executed by the one or more processors, further cause the imaging system to execute image processing of performing adjustment of a hue of an output image of the first area by performing image processing on the original image in the first area using a hue correction parameter set for the first area.
